(19) United States
(12) Patent Application Publication
(10) Pub. No.: US 2011/0262130 A1
(43) Pub. Date: Oct. 27, 2011

(54) ELECTRONIC APPARATUS HAVING MEANS FOR SUPPRESSING SIGNAL REFLECTIONS FROM AN INTERNAL SIGNAL SOURCE

(76) Inventors: Markus Lindner, Stuttgart (DE); Dietmar Grimm, Moeglingen (DE); Volker Burkhardt, Ehningen (DE)

(21) Appl. No.: 12/737,594

(22) PCT Filed: Jun. 25, 2009
(86) PCT No.: PCT/EP2009/057997

§ 371 Date: Apr. 21, 2011

(30) Foreign Application Priority Data
Jul. 31, 2008 (DE) 10-2008-040-907.3

(51) Int. Cl. H04K 3/00

(52) U.S. Cl. 398/39

(57) ABSTRACT

An electronic apparatus, e.g., a central signal unit for a vehicle, has a signal receiver which operates in the optical wavelength range for receiving signals of an external signal source, and an internal signal source for emitting signals which are different from signals of the external signal source, and which operates essentially in a wavelength range which is the same as or directly adjacent to the wavelength range of the external signal source. The signal receiver and the internal signal source are situated in the apparatus behind a reflective cover. The apparatus includes a suppression unit which prevents generation of interference signals at the signal receiver.

### BACKGROUND OF THE INVENTION

1. Field of the Invention

The present invention relates to an electronic apparatus, in particular a central signal unit for a vehicle, having a signal receiver operating in the optical wavelength range for receiving signals of an external signal source, and an internal signal source which operates essentially in the same or the adjacent frequency range.

2. Description of Related Art

Published German patent application document DE 195 06 723 A1 describes an electronic entertainment device having a remote control unit. To allow audio playback using a playback device, for example in the form of headphones, provided separately from the entertainment device, the cited document proposes to provide, in addition to a first infrared path from the remote control unit to the entertainment device, a second infrared path from the entertainment device to the remote control unit. The infrared transmitter for this second infrared path, situated on the entertainment device, transmits the audio signals which are modulated on the infrared transmitter to an infrared receiver situated in the remote control unit, and the signals of the infrared receiver are conditioned via an appropriate circuit and are relayed to a headphone jack likewise provided on the remote control unit.

Published German utility model application document DE 298 02 997 U1 describes an audio playback system having wireless transmission of audio signals from the audio source to an audio playback device, and having a wireless return channel.

Infrared remote control units function only when there is proper, direct visual contact between the infrared transmitter and the infrared receiver. To allow such an audio source to also be operated from positions other than those having direct visual contact with the infrared receiver situated therein, using infrared remote control, the cited document proposes to provide a second infrared receiver on a playback device, such as a speaker or headphones, for example, to condition the infrared signal which it receives, using an appropriate circuit, and to transmit the signal to the entertainment device with the aid of a so-called wireless return channel which includes a wireless transmitter and a wireless receiver, to recondition the signal in the entertainment device with the aid of a further circuit, and to modulate the signal with the aid of a further, second infrared transmitter directed to the first infrared receiver situated in the entertainment device, and to relay the remote control signal to the audio source via this additional infrared path.

It is also known to use remote-controllable electronic apparatuses in vehicles. To allow, for example, savings in wiring and/or greater flexibility in the positioning of playback devices such as speakers, for example, which are to be connected to the apparatus, wireless connections to the electronic device, likewise in the form of infrared paths, for example, may be implemented here as well.

An object of the present invention is to improve the related art described at the outset.

### BRIEF SUMMARY OF THE INVENTION

The present invention provides an electronic apparatus, in particular a central signal unit for a vehicle, having a signal receiver which operates in the optical wavelength range, in particular in the infrared range, for receiving signals of an external signal source, for example a remote control unit, and having an internal signal source for emitting signals, for example audio signals, which are different from signals of the external signal source. This apparatus is characterized in that suppression means are provided which prevent generation of interference signals at the signal receiver which may result from reflections of signals of the internal signal source.

Such an apparatus design is based on the finding that problems arise in the evaluation of signals detected by the receiver, in particular for electronic apparatuses having a compact design, which may be implemented in the form of combined instruments for vehicles, for example, having two wireless transmission channels which operate separately from one another. As a result of these problems, for example, on the one hand signals from an external signal source, such as a remote control unit, for example, which are directed to the internal signal receiver are not unambiguously recognized, and/or signals are recognized by the signal receiver, and are evaluated in the applicable electronic circuit as control signals which originate not from the associated external signal source, but, rather, in particular from the second internal signal source, situated in the electronic apparatus, of a second wireless transmission path, for example an infrared audio transmission path.

This has been attributed in particular to reflected beams which, for example, are deflected toward the signal receiver on other components of the electronic apparatus, for example covers in the form of cover plates for signal devices or the like.

Interference signals are understood to mean signals which are spuriously generated by the signal receiver and which are caused by incoming radiation, in particular irradiation from reflected signals of the internal signal source, which is intense enough to generate a signal. To prevent the generation of such interference signals, in the ideal case the suppression means completely suppress such incoming radiation from undesired, in particular reflected, signals of the internal signal source on the internal signal receiver. Applications are also possible in which a certain portion of reflected scattering signals reach the signal receiver, and in which sufficiently good operation of an affected apparatus is possible when interference signals are not completely prevented. For cases in which sufficiently reliable operation is not possible when interference signals are not completely prevented, such interference signals may be suppressed, for example, using an electronics system connected downstream from the signal receiver in order to avoid an unacceptable, erroneous output of a signal in the form of an interference signal.

Such an erroneous response of the signal receiver is easily possible, in particular due to signals of the internal signal source (W/m²) which may be up to 1000 times stronger than the signals (mW/m²) emitted by the external signal source.

Since, depending on the application, the reflection of a small portion of the signals emitted by the internal signal source is often sufficient to interfere with proper operation of the wireless path which includes the internal signal receiver, in one preferred specific embodiment it is proposed to provide a signal shadowing element as the means for suppressing interference signals or scattering signals which originate in particular from the internal signal source.

Such a signal shadowing element may be designed, for example, as a panel-shaped element, for example in the form of a wall, a rib, a web, or the like, preferably made of a material which is impermeable to or at least strongly damping for the wavelength in question, which prevents optical contact between a reflected scattering signal of the internal signal source and the signal receiver to be shadowed, thus allowing suppression of at least a majority of the reflections to the signal receiver.

In particular, a shielding effect may be achieved, for example, by providing a geometric optical system in the incoming radiation region of the signal receiver which limits the effective angle of incidence for the signal receiver. For example, for this purpose a cover having an aperture oriented in the reception direction with respect to the external signal source could be provided in front of the signal receiver. By varying the aperture diameter and the distance between the aperture and the surface of the signal receiver which is sensitive to the signal, a first, very effective shielding from interference signals caused by reflections, in particular from the internal signal source, may be implemented, while at the same time providing sufficient sensitivity for detecting the signals originating from the external signal source.

In an example embodiment, the signal shadowing element may also be designed as a panel-shaped element such as a wall, a rib, a web, or the like, which is situated on and/or in front of the cover of the electronic apparatus, so that, for example, in the reflection region of the reflective cover appropriate signal shadowing may be achieved, alternatively or in addition to further signal suppression means.

In another example embodiment, an optical filter may also be provided, once again alternatively or in addition to the above-described signal shadowing elements. This optical filter may be implemented, for example, as an absorption filter, for example in the form of an appropriately colored material.

In another example embodiment, the optical filter may also be designed as an interference filter. As a result of the thin layers used for this purpose, a signal selection may advantageously be implemented which is greatly dependent on the angle. In this way, on the one hand the transmitting region may advantageously be adapted to the angle of incoming radiation of the external transmission source, for example as a function of a certain wavelength, and on the other hand a very good blocking filtering effect may be achieved for wavelengths which differ from the certain wavelength.

The optical filters suppress generation of interference signals in a particularly effective manner in particular when the internal signal receiver operates in a wavelength range which is different from the internal signal source. In such a case, appropriate optical filters may even be provided for both wavelength ranges if necessary, thus allowing a double suppression measure against the generation of interference signals. The first measure is provided directly at the transmission source and/or at least in the transmission cone thereof, by providing a filter which only allows emission in the precise transmission wavelength range provided, and the second measure is provided, in front of the internal signal receiver, which is precisely tuned to the reception frequency, and is likewise provided either directly at the receiver and/or in the signal reception cone thereof.

Depending on the desired shielding effect and/or the limitation of a transmission cone, one or several of the above-referenced optical filters, alone and/or in combination, may be combined with the example embodiments of signal shadowing elements described at the outset.

In another example embodiment, an optical fiber, in particular an encapsulated optical fiber, may be situated in front of the signal receiver. In particular, an element which shields the optical fiber toward the reflection surface of the cover for the frequency or wavelength range in question is understood as encapsulation within the meaning of the present patent application. This element may, but does not necessarily have to be, closed around a longitudinal extension of the optical fiber. The critical factor is sufficiently good shielding of the optical fiber from the incoming radiation of extraneous signals, in particular of reflected transmission radiation of the internal signal source.

Using an optical fiber encapsulated in this way, a signal emitted by the external signal source may be received at the input side of the optical fiber, and, essentially without other interfering signals, may be transmitted as a cleanly detectable control signal to the signal receiver and recognized by same in an error-free manner.

With regard to the options for combining suppression means, it is basically pointed out once more that all of the described example embodiments may also be combined with one another in different forms and configurations.

### BRIEF DESCRIPTION OF THE DRAWINGS

FIGS. 1-3 schematically show example embodiments of an electronic apparatus, in particular a central signal unit for a vehicle.

### DETAILED DESCRIPTION OF THE INVENTION

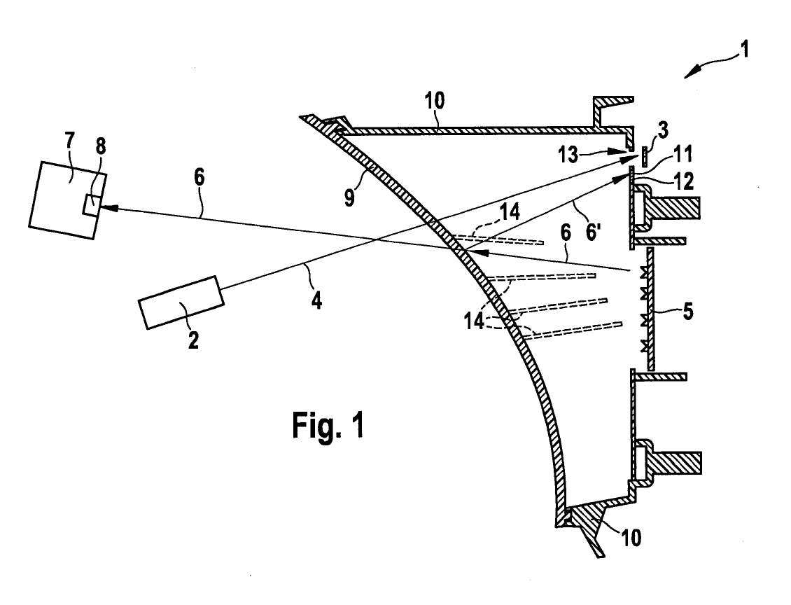

In detail, FIG. 1 shows a sectional illustration as an example of an electronic apparatus 1, for example in the form of a central signal unit for a vehicle, and an external signal source 2, for example in the form of a remote control unit for operating the electronic apparatus.

Central signal unit 1 includes a signal receiver 3, which operates in the optical wavelength range, for detecting signals 4 emitted by remote control unit 2. Central signal unit 1 also includes an internal signal source 5. In one special application, this internal signal source 5 may operate in a wavelength range which is the same as or directly adjacent to the wavelength range of the external signal source, such as 850 nm or 950 nm, for example. However, much greater differences between the two base wavelengths are also possible.

Signals 6 emitted by internal signal source 5 are different from control signals 4 emitted by remote control unit 2, and upon exiting the central signal unit are oriented for supplying an external signal receiver 8, situated in a peripheral device 7, with signals 6. For example, in this way audio signals 6 could be transmitted to a speaker 7 for playback.

Since a housing 10 of central signal unit 1 of the vehicle has a cover 9, for example in the form of a cover plate for display instruments, for example for protecting the individual components, signals 6 emitted by internal signal source 5 must penetrate cover plate 9, as the result of which a portion of the radiation is reflected back into the interior of signal unit 1 as a reflection signal 6′ toward internal signal receiver 3, among other directions.

To suppress incoming radiation of these reflected signals 6′ to internal signal source 3, according to the present invention suppression means 11 are provided, which in the example embodiment illustrated in a symbolic form and as an example in FIG. 1 are designed as panel-like elements 12, for example in the form of wall-like shadowing means 12, and are situated at a suitable distance in front of the internal signal receiver in such a way that it is no longer possible for the internal signal receiver to be acted on by reflected radiation 6′.

In the example illustrated here, this signal shadowing element designed in the form of a wall 12 delimits an aperture 13 which in a manner which is selective for a signal cone allows direct visual contact with remote control unit 2, but reliably shadows such a signal cone from scattered radiation 6′ which is reflected on cover 9.

As a further possible example embodiment of a signal shadowing element 12, which once again is strictly symbolic and provided as an example, four ribs 14 are illustrated as dashed lines.

These ribs may be situated on and/or in front of cover 9 in such a way that they allow signal beams 6 exiting in each case from one or multiple internal signal sources 5 to pass through cover 9 toward an external signal receiver 8 which is to be irradiated in each case, but scattered radiation 6′, reflected on cover 9, is already shadowed in the surrounding region of the resulting reflections, thus preventing direct visual contact with internal signal receiver 3.

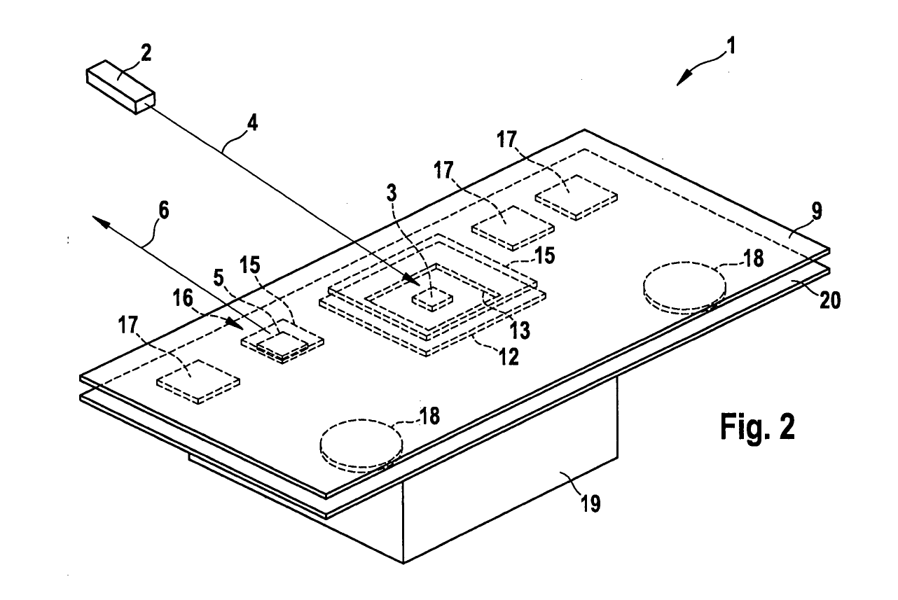

FIG. 2 shows one example embodiment, likewise'as an example in symbolic form, in which central signal unit 1 for a vehicle includes an optical filter 15. Such an optical filter 15 may be designed as an absorption filter, or also as an interference filter. Such optical filters may be situated on and/or in front of internal signal receiver 3, and also on and/or in front of internal signal source 5, to prevent reflected scattered radiation from internal signal source 5 from irradiating internal signal receiver 3.

Such optical filters are advantageous in particular at base frequencies or wavelengths which are at least slightly different from one another, so that in each case only the wavelength which is tuned to the particular optical filter passes through.

Using an appropriate geometric configuration, in turn a selective optical system for signals having the same frequency may be implemented, for example, by appropriately varying the irradiation characteristics of internal signal source 5 by selecting an appropriate transmittance region and/or an appropriate distance between such a “transmittance window” 16 and the irradiation surface of internal signal source 5. For example, the smaller the irradiation cone of internal radiation source 5 which is thus implemented, the narrower the critical reflection region which may be kept on cover plate 9.

In the most favorable case, no further shadowing elements are necessary. In any case, however, the above-described measures for shadowing the internal signal receiver from reflected radiation may advantageously be reduced or simplified by such a reduction in the critical reflective surface area.

In particular, cover 9 may also have a particularly translucent design, at least in the region of and at least for the wavelength of internal signal source 5 in which a signal beam is to be emitted to appropriate external receivers 8. However, a more translucent design of the cover is also possible, at least in the region of incoming radiation with respect to the internal signal receiver, in particular for the reception wavelength range in question.

In the perspective top view of central signal unit 1 shown in FIG. 2, cover 9 is illustrated as a large-surface upper layer at a slight distance from a back wall 20, on and/or in which further signal elements 17, 18 are illustrated as an example in symbolic form. A control unit 19 for conditioning and/or displaying various signals may be provided behind rear wall 20, as viewed from the direction facing cover 9.

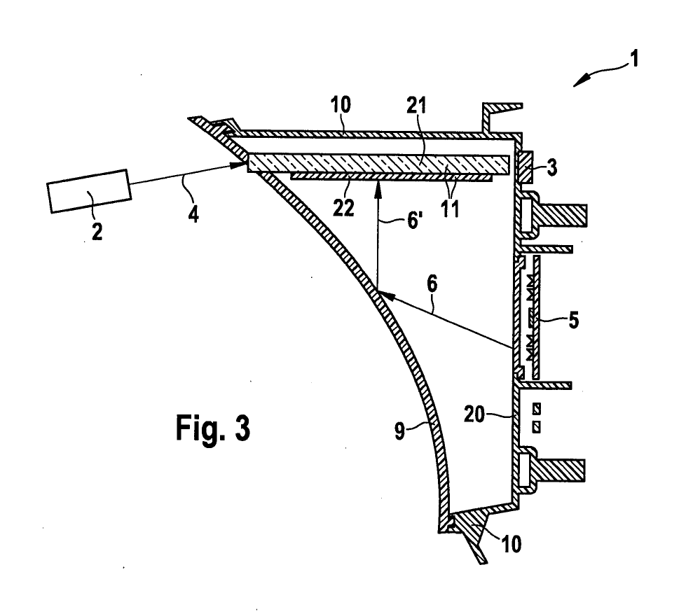

FIG. 3 shows, once again as an example and in symbolic form, another example embodiment of a signal unit 1 for a vehicle.

In this case, means 11 for suppressing irradiation of scattering signals 6′ emitted from internal signal source 5 and reflected on cover 9 onto internal signal receiver 3 include an optical fiber 21 which is provided with encapsulation 22.

Optical fiber 21 is shielded to the inside from signals reflected in particular on the reflective surface of cover 9 by encapsulation 22, which as an example is illustrated here in symbolic form as a bar 22. Encapsulation 22 may essentially completely enclose optical fiber 21 in the longitudinal extension thereof, although this is not absolutely necessary. Thus, for example, a planar cover, at least in the critical regions of incoming radiation, may provide sufficient shadowing of internal signal receiver 3.

As the result of such shielding from reflected beams 6′, signals 4 emitted by remote control unit 2 may be transmitted to internal signal receiver 3 essentially without overlap with scattering signals, thus allowing signal receiver 3 to correctly detect the signals, and the logic unit connected downstream therefrom to properly execute the control instructions thus transmitted.

1-12. (canceled)

13. A central signal unit for a vehicle, comprising:
a signal receiver configured to operate in the optical wavelength range for receiving signals of an external signal source, wherein the signal receiver has an internal signal source configured to emit signals different from signals of the external signal source; and
a suppression unit configured to prevent generation of interference signals at the signal receiver due to reflections of signals of the internal signal source.

14. The electronic apparatus as recited in claim 13, wherein the suppression unit includes a signal shadowing element.

15. The electronic apparatus as recited in claim 14, wherein the signal shadowing element is configured as a panel-shaped element preventing optical contact between a reflected signal of the internal signal source and the signal receiver.

16. The electronic apparatus as recited in claim 14, wherein the signal shadowing element is configured as a wall at least partially delimiting an aperture configured to enable optical contact with the signal receiver.

17. The electronic apparatus as recited in claim 14, further comprising:
a cover;
wherein the signal shadowing element is configured as a panel-shaped element situated one of on the cover or in front of the cover.

18. The electronic apparatus as recited in claim 13, wherein the suppression unit is configured as at least one optical filter.

19. The electronic apparatus as recited in claim 18, wherein the optical filter is configured as an absorption filter.

20. The electronic apparatus as recited in claim 18, wherein the optical filter is configured as an interference filter.

21. The electronic apparatus as recited in claim 18, wherein the optical filter is situated one of on the signal receiver or in front of the signal receiver.

22. The electronic apparatus as recited in claim 18, wherein the optical filter is situated one of on the internal signal source or in front of the internal signal source.

23. The electronic apparatus as recited in claim 13, further comprising:
a cover, wherein the cover is translucent for the wavelength of radiation emitted by the internal signal source.

24. The electronic apparatus as recited in claim 13, further comprising:
an encapsulated optical fiber situated in front of the signal receiver.
